(19) United States
(12) Patent Application Publication
(10) Pub. No.: US 2009/0055908 A1
(43) Pub. Date: Feb. 26, 2009

(54) Apparatus and method for accessing user cookies between network domains

(75) Inventor: Neal D. Rapoport, Plano, TX (US)

Correspondence Address: DOCKET CLERK, P.O. DRAWER 800889, DALLAS, TX, 75380, US

(73) Assignee: NARAE Enterprises, Inc., Plano, TX (US)

(21) Appl. No.: 11/894,410

(22) Filed: Aug. 21, 2007

(51) Int. Cl. H04L 9/32; G06F 17/00

(52) U.S. Cl. 726/6; 726/9

(57) ABSTRACT

Multiple network domains may be grouped together. One network domain may represent a primary domain, while one or more additional network domains may represent secondary domains. User cookies associated with users may be stored in the primary domain. When a user attempts to access the primary domain, the primary domain may retrieve and use the user cookie to log the user into the primary domain. When a user attempts to access a secondary domain, the secondary sends a request to the primary domain. The primary domain sends the user cookie or related information (such as a token) to the secondary domain, which uses the user cookie or related information to log the user into the secondary domain. In addition, an active session between the user and one of the network domains can be transferred to another network domain.

### TECHNICAL FIELD

This disclosure is generally directed to network systems and more specifically to an apparatus and method for accessing user cookies between network domains.

### BACKGROUND

Many different websites support the use of cookies to facilitate communications with users. For example, a web server often provides a cookie to a user's web browser when the web browser attempts to access and communicate with the web server. The cookie is usually stored locally by the web browser, such as in a text file. Information in the cookie can then be sent back to the web server at an appropriate time.

Cookies can be used to support a wide variety of functions. For example, cookies are often used to authenticate users or to track the users' activities. Cookies can also be used to maintain information about a user, such as the user's preferences related to the content and arrangement of a web page (which allows the presentation of customized web pages to the user).

### SUMMARY

This disclosure provides an apparatus and method for accessing user cookies between network domains.

In a first embodiment, a method includes storing, in a first network domain, a cookie associated with a user. The method also includes receiving, at a second network domain, login information associated with the user. The method further includes communicating a request from the second network domain to the first network domain. In addition, the method includes providing the cookie or information associated with the cookie from the first network domain to the second network domain in response to the request.

In particular embodiments, the method also includes logging the user into the second network domain using the cookie or the information associated with the cookie.

In other particular embodiments, the method also includes creating an active session associated with the second network domain and a user device used by the user. The active session can be maintained when the user device accesses the first network domain or a third network domain.

In yet other particular embodiments, multiple users are capable of logging into the first and second network domains, and multiple cookies for the multiple users are stored only in the first network domain.

In still other particular embodiments, the method also includes receiving a registration request from the user at the second network domain or at a third network domain and redirecting the user to the first network domain. The method further includes receiving registration information from the user at the first network domain, generating the cookie, and redirecting the user back to the second or third network domain.

In additional particular embodiments, the method also includes receiving a registration request from the user at the second network domain or at a third network domain and providing a registration form to the user. The registration form is defined in the first network domain. The method further includes receiving registration information from the user using the registration form and communicating the registration information from the second or third network domain to the first network domain for generation of the cookie.

In a second embodiment, a system includes a first network domain having at least one first server and a database and a second network domain having at least one second server. The database is configured to store a cookie associated with a user. The at least one second server is configured to receive login information associated with the user. The at least one first server is configured to provide the cookie or information associated with the cookie to the at least one second server.

In a third embodiment, a method includes storing, in a first network domain, a cookie associated with a user. The method also includes receiving a request for the cookie or information associated with the cookie from a second network domain. In addition, the method includes providing the cookie or the information associated with the cookie to the second network domain.

In a fourth embodiment, an apparatus is associated with a first network domain and includes at least one memory configured to store a cookie associated with a user. The apparatus also includes at least one processor configured to receive a request for the cookie or information associated with the cookie from a second network domain and to provide the cookie or the information associated with the cookie to the second network domain.

In a fifth embodiment, a computer program is embodied on a computer readable medium. The computer program includes computer readable program code for storing a cookie associated with a user in a first network domain. The computer program also includes computer readable program code for receiving a request for the cookie or information associated with the cookie from a second network domain. In addition, the computer program includes computer readable program code for providing the cookie or the information associated with the cookie to the second network domain.

In a sixth embodiment, a method includes receiving, at a first network domain, login information from a user. The method also includes communicating a request from the first network domain to a second network domain. The method further includes receiving a cookie associated with the user or information associated with the cookie from the second network domain in response to the request. In addition, the method includes logging the user into the first network domain using the cookie or the information associated with the cookie.

In a seventh embodiment, an apparatus is associated with a first network domain and includes at least one network interface configured to communicate over a network. The apparatus also includes at least one processor configured to receive login information from a user, communicate a request to a second network domain, receive a cookie associated with the user or information associated with the cookie from the second network domain in response to the request, and log the user into the first network domain using the cookie or the information associated with the cookie.

In an eighth embodiment, a computer program is embodied on a computer readable medium. The computer program includes computer readable program code for receiving login information from a user at a first network domain and for communicating a request from the first network domain to a second network domain. The computer program also includes computer readable program code for receiving a cookie associated with the user or information associated with the cookie from the second network domain in response to the request. In addition, the computer program includes computer readable program code for logging the user into the first network domain using the cookie or the information associated with the cookie.

In a ninth embodiment, a method includes receiving, at a first network domain, a registration request from a user. The method also includes receiving information defining a registration form from a second network domain and providing the registration form to the user. The method further includes receiving registration information from the user using the registration form. In addition, the method includes communicating the registration information to the second network domain for generation of a user cookie.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for accessing user cookies between network domains according to this disclosure;

FIGS. 2A through 2C illustrate example web pages associated with different network domains according to this disclosure;

FIGS. 3A and 3B illustrate example web pages supporting login and registration functions based on access to user cookies between network domains according to this disclosure;

FIG. 4 illustrates an example method for logging a user into a network domain using a user cookie accessible from multiple network domains according to this disclosure; and

FIG. 5 illustrates an example method for using, in a secondary network domain, a user cookie stored in a primary network domain according to this disclosure.

### DETAILED DESCRIPTION

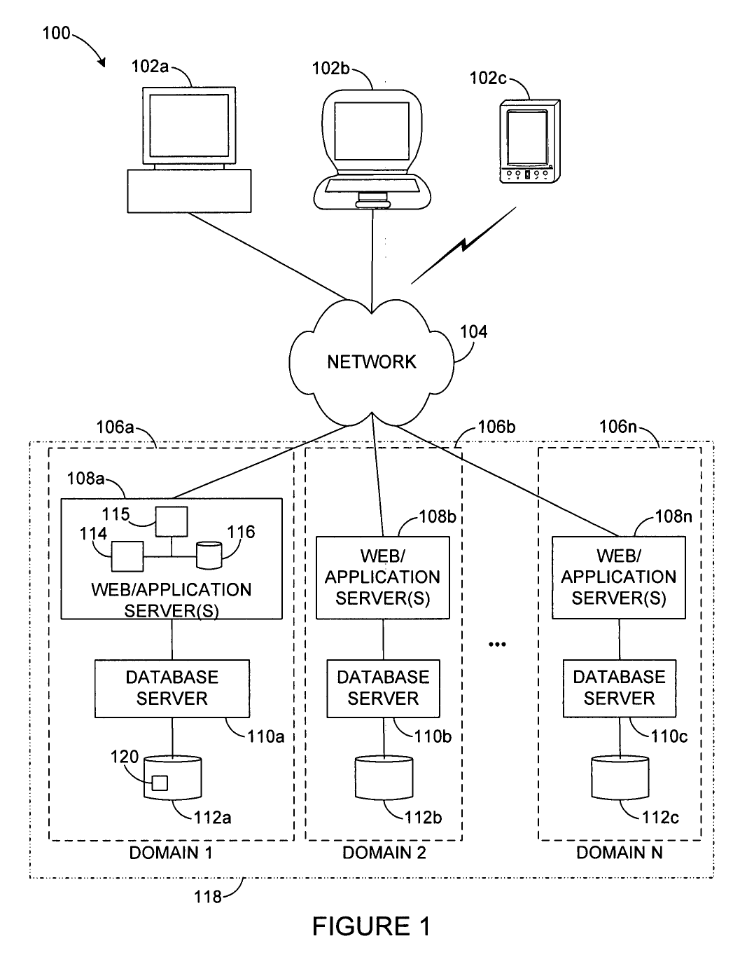

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for accessing user cookies between network domains according to this disclosure. The embodiment of the system 100 shown in FIG. 1 is for illustration only. Other embodiments of the system 100 may be used without departing from the scope of this disclosure.

In this example embodiment, the system 100 includes various end user devices 102a-102c. Each of the user devices 102a-102c communicates over a network 104. For example, each of the user devices 102a-102c may receive and display a web page to a user, and the user could use the user device 102a-102c to provide information via the web page. In this particular example, the user devices 102a-102c include a desktop computer (102a), a laptop computer (102b), and a personal digital assistant (102c). Each of these user devices 102a-102c communicates over a wired or wireless connection. These user devices 102a-102c are for illustration only. Any other or additional computing or communication devices may be used in the system 100. Each of the user devices 102a-102c includes any suitable structure allowing a user to communicate and interact over a network.

A network 104 is capable of communicating with the user devices 102a-102c and with various other components attached to the network 104. The network 104 facilitates communication between components in the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

In this example, the system 100 includes multiple network domains 106a-106n. The network domains 106a-106n represent different components or groups of components in the system 100 that are associated with different network domains, such as different domain names like www.domain1.com and www.domain2.com. As shown here, the network domains 106a-106n include web and/or application servers 108a-108n, database servers 110a-110n, and databases 112a-112n.

The web/application servers 108a-108n are capable of supporting a wide variety of functions in the network domains 106a-106n. For example, the servers 108a-108n could include web server functionality supporting communication and interaction with the user devices 102a-102c over the network 104, such as by generating web pages and providing the web pages to the user devices 102a-102c over the network 104. The servers 108a-108n could also include application server functionality performing any of a wide variety of operations for users using the user devices 102a-102n. As particular examples, the server(s) 106a could be used to search for and identify discounts or other offers related to products or services (which could then be presented to users using the web server functionality). The server(s) 106b could be used to search for and identify prices and other information related to products or services (which again could be presented to users using the web server functionality). The server(s) 106n could be used to store information identifying products or services in a gift registry (which once again could be presented to users using the web server functionality). The servers 108a-108n could support any other or additional functionality depending on particular needs.

The servers 108a-108n could use any suitable protocol(s) to communicate with the user devices 102a-102c. For example, the servers 108a-108n could support the use of hypertext markup language (HTML) to communicate web pages to the user devices 102a-102c. The servers 108a-108n could also support Secure Sockets Layer (SSL) or other techniques to facilitate secure communications with the user devices 102a-102c.

Each of the servers 108a-108n includes any suitable structure for supporting network communications and for performing any of a wide variety of other functions. As a particular example, each of the servers 108a-108n could include one or more processors 114, one or more network interfaces 115, and one or more memories 116 containing instructions and data used, generated, or collected by the one or more processors 114. The one or more network interfaces 115 could include any suitable structures for communicating over the network 104, such as an Ethernet interface.

The database servers 110a-110n are coupled to the corresponding servers 108a-108n and the corresponding databases 112a-112n. Each of the databases 112a-112n stores various information used, collected, or generated by its associated web/application server or otherwise used, collected, or generated in its associated network domain. For instance, in the network domain 106a, the database 112a could store information identifying discounts or other offers related to products or services. In the network domain 106b, the database 112b could store information identifying prices and other pricing-related information for products or services. In the network domain 106n, the database 112n could store information identifying products or services in various gift registries.

The database servers 110a-110n provide access to and control over the data stored in the databases 112a-112n. For instance, the database servers 110a-110n can support the storage of data in and the retrieval of data from the databases 112a-112n. The database servers 110a-110n may also ensure that components attempting to access the databases 112a-112n are authorized.

Each of the database servers 110a-110n includes any suitable structure for providing access to a database of information. Each of the databases 112a-112n includes any suitable structure for storing and facilitating retrieval of information. Each of the databases 112a-112n also uses any of a variety of data structures, arrangements, and compilations to store and facilitate retrieval of information.

In one aspect of operation, users that access the various network domains 106a-106n are associated with user cookies. For example, the web/application servers 108a-108n could provide cookies to the user devices 102a-102c when the user devices 102a-102c access the network domains 106a-106n. The cookies typically include information associated with the users and can be used in a variety of ways, such as to authenticate users, track the users' activities, maintain preference or other information about the users, and generate customized web pages for the users. When a user logs into a network domain 106a-106n, a session is typically established between the web/application server in that network domain and the user's device. The establishment of a session often involves the retrieval of a cookie from the user's device (if one already exists at the user's device) or the presentation of a cookie to the user's device (if one does not already exist at the user's device).

Conventional systems typically lack a mechanism for transferring a user session between network domains. For example, a user could access and establish a session with a first website www.domain1.com in a first network domain. If the user then attempts to access a second website www.domain2.com in a second network domain, the user would typically be required to establish another session with the second network domain. In these conventional systems, there was no sharing of cookies between the different network domains.

In accordance with this disclosure, various network domains 106a-106n can be grouped together into a site group 118. The site group 118 represents a collection of network domains, where user cookies can be shared between network domains and where an active session in one network domain can be transferred to another network domain.

In this example embodiment, the network domain 106a may represent a primary domain, while the other network domains 106b-106n may represent secondary domains. In this particular embodiment, user cookies 120 are stored in the primary domain, such as in the database 112a of the primary network domain 106a. The cookies 120 could be stored in a database in any suitable manner, such as in a table or other database structure. The cookies (or related information associated with the cookies) can be used in the primary domain or passed to any of the secondary domains for use.

When a user attempts to log into a primary network domain, the user's cookie can be retrieved from the primary domain and used to log the user into the primary domain. When the user attempts to log into a secondary domain, the secondary domain requests the user's cookie from the primary domain. The user's cookie or related information (such as a login, session, or other token) can be passed from the primary domain to the secondary domain and used to log the user into the secondary domain.

In this way, the same cookie associated with a particular user can be accessed and used across multiple network domains. This means, for example, that user preferences can be enforced across multiple domains. It also means that cookies or related information can be transferred between network domains, allowing a session involving a user to remain active even when the user moves between network domains in the site group 118.

Although FIG. 1 illustrates one example of a system 100 for accessing user cookies between network domains, various changes may be made to FIG. 1. For example, the system 100 may include any number of user devices, networks, network domains (primary and secondary), site groups, web/application servers, database servers, and databases. Also, the functional division shown in FIG. 1 is for illustration only. Various components in FIG. 1 could be combined or omitted and additional components could be added according to particular needs. In addition, while FIG. 1 illustrates one operational environment in which user cookies can be accessed between network domains, this functionality could be used in any other suitable system.

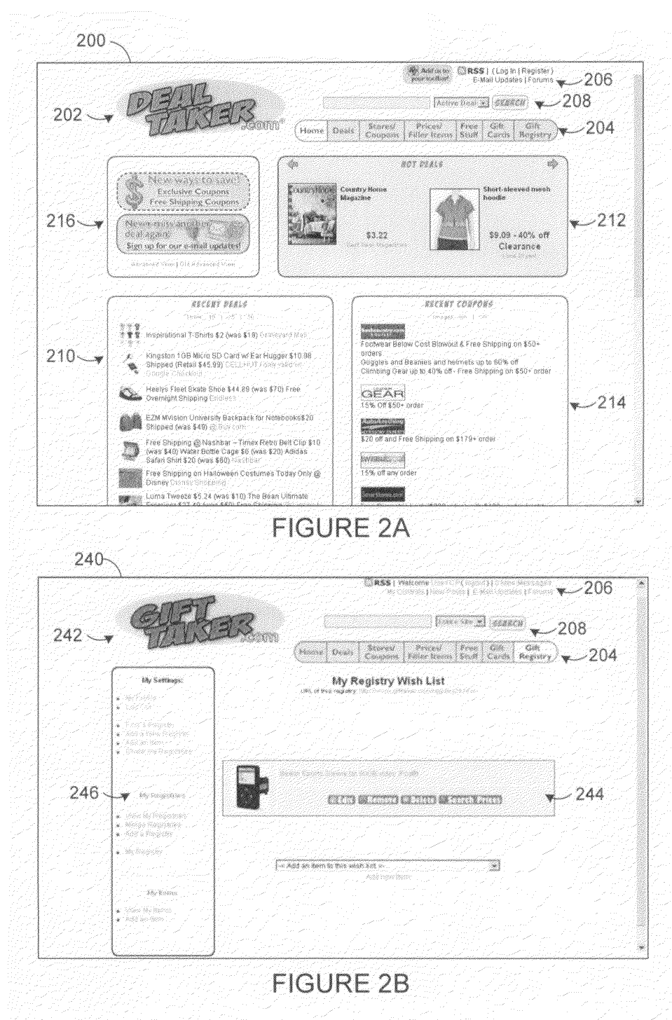

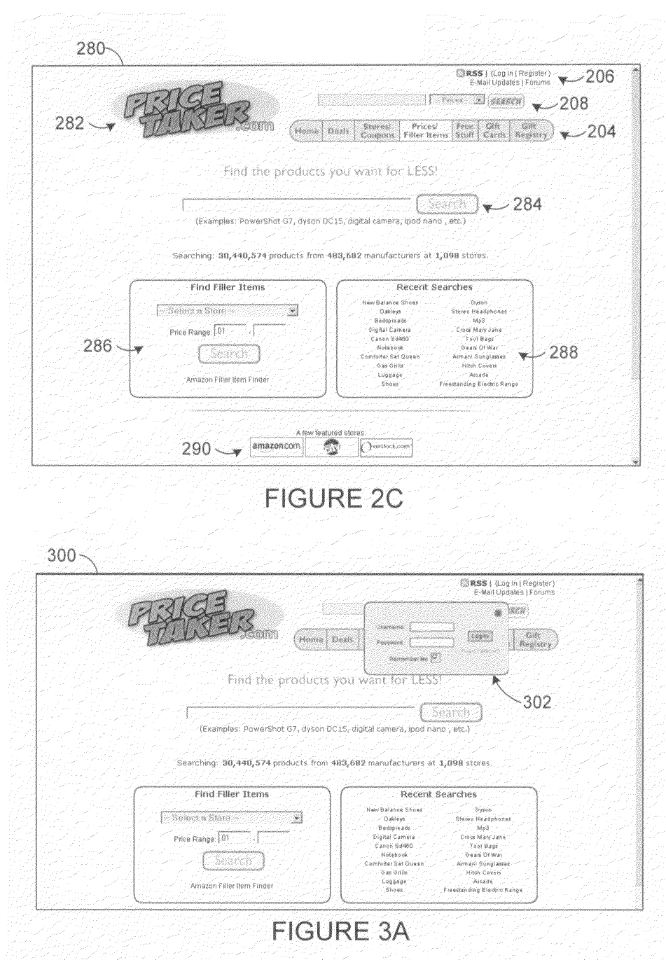

FIGS. 2A through 2C illustrate example web pages associated with different network domains according to this disclosure. For example, FIGS. 2A through 2C could represent web pages used in different ones of the network domains 106a-106n in FIG. 1. The web pages shown in FIGS. 2A through 2C are for illustration only. Any other suitable web pages could be used without departing from the scope of this disclosure.

In FIG. 2A, a web page 200 is used to support searches for discounts and other offers related to products or services. In this document, the term “offer” and its derivatives refer to any offer to provide a product or service. For example, offers include an offer to sell a product or service at a specified price or an offer to sell a product or service at a discount (such as a price reduced via a coupon, sale, or other deal). Also, the term “discount” and its derivatives refer to any reduction in the price or associated charges (such as shipping costs) related to a product or service, such as coupons for a product or service honored by a vendor. Further, the term “vendor” and its derivatives refer to any individual, business, or other entity offering a product or service. In addition, the term “item” and its derivatives are used in this patent document to denote both products and services.

In this example, the web page 200 includes various information and controls at the top of the web page 200. For example, the web page 200 includes a logo 202 identifying the company that owns or operates the website being accessed. The web page 200 also includes various tabs 204, which can be used to access different types of information and, as explained below, to redirect a user to different network domains.

The web page 200 further includes login information and controls 206, which allow a user to log in or register with a network domain. For example, selection of the “Log In” option in the login information and controls 206 allows the user to log into any of the network domains 106a-106n using a cookie stored in the primary network domain. Similarly, selection of the “Register” option in the login information and controls 206 allows a user to register with the site group and leads to the creation of a cookie in the primary network domain.

As noted above, the web page 200 is used to provide discounts and other product or service offers to users. To that end, the web page 200 includes a text search 208, which allows a user to search for desired offers. As a particular example, the user could enter text (such as a product, manufacturer, or store name), specify which offers to search (such as active or expired offers), and initiate the search. Also, a “Recent Deals” section 210 identifies various offers for products or services, and a “Hot Deals” section 212 identifies offers for products or services that may be particularly useful or beneficial. A “Recent Coupons” section 214 identifies various discounts for products or services. The contents of these sections 210-214 can be selected in any suitable manner. General options 216 allow the user to view particular information or to register to receive information.

In FIG. 2B, a web page 240 is used to support the creation, maintenance, and review of gift registries. Gift registries allow certain users to identify products or services they wish to receive. Other users may then review the gift registries and optionally review information about and purchase the identified products or services. In this example, the web page 240 again includes various information and controls at the top of the web page 240. For example, the web page 240 includes a logo 242 identifying the company that owns or operates the website being accessed.

As shown here, the web page 240 also includes the tabs 204, the login information and controls 206, and the text search 208. In this example, a user has logged into a network domain, and the login information and controls 206 includes other information and controls (compared to FIG. 2A). For example, the login information and controls 206 include the user's login name, the number of messages awaiting the user, and an option to log out of the network domain. The login information and controls 206 also allow the user to access an administrator control panel (CP) and other controls for controlling the user's account and other aspects of the user's participation in the network domains. The login information and controls 206 further allow the user to view new posts in a forum, access a forum, view e-mail updates for the user, and perform any other or additional tasks or operations.

The web page 240 further includes one or more gift registry entries 244. Each gift registry entry 244 identifies a particular product or service placed into a user's gift registry by that user. Each gift registry entry 244 includes a name of an item (which may also be used as a hyperlink that can be selected to obtain the item). The gift registry entry 224 may also include an image of the item. In addition, the gift registry entry 224 includes buttons allowing the user to edit to gift registry entry 224, remove the gift registry entry 224 from the current gift registry, delete the gift registry entry 224 from all gift registries, and search for prices related to the identified item.

The web page 240 further includes various settings 246 that can be selected. For example, the settings 246 may allow the user to view his or her profile and to log into or out of the gift registry network domain. The settings 246 may also allow the user to locate, view, modify, share, and delete gift registries and to locate, view, and add items to the gift registries. Any other or additional settings 246 could be provided to the user.

In FIG. 2C, a web page 280 is used to search for prices for products and services, such as prices for particular products or services, for particular types of products or services, or from particular vendors. In this example, the web page 280 again includes a logo 282, the tabs 204, the login information and controls 206, and the text search 208.

The web page 280 also includes an item search 284, which allows users to search for pricing information related to various products or services. A filler item search section 286 allows users to select a particular vendor from a drop-down menu and then search for items within a specified price range. A recent searches section 288 identifies various searches that have been made for product or service pricing information, such as the most common or most popular searches. Icons 290 are associated with different vendors and represent hyperlinks that can be selected to view the vendors' websites.

As shown by the different logos 202, 242, and 282 in FIGS. 2A through 2C, the web pages 200, 240, and 280 are associated with different domain names (www.dealtaker.com, www.gifttaker.com, and www.pricetaker.com, respectively). As a result, these web pages 200, 240, and 280 may be associated with different network domains, such as the domains 106a-106n in the system 100. One of these web pages could be associated with a primary domain in a site group 118 (such as the web page 200). The other web pages could be associated with secondary domains in the site group 118 (such as the web pages 240 and 280). In this example, the network domain associated with the web page 200 could store the user cookies associated with various users that access the site domain 118. When a user attempts to log into or access the primary domain (via the web page 200), the primary domain uses the user's cookie to facilitate the login process. When a user attempts to log into or access one of the secondary domains (via the web page 240 or 280), the primary domain provides the user's cookie or related information to the secondary domain to facilitate the login process. In particular embodiments, all of the web pages 200, 240, and 280 could be associated with network domains that are related in some way (such as through a common owner or operator). This may allow the common owner or operator to know that user cookies from one network domain can be safely provided to components of another network domain.

Although FIGS. 2A through 2C illustrate examples of web pages associated with different network domains, various changes may be made to FIGS. 2A through 2C. For example, each web page could include any other or additional information, and each web page could have any suitable arrangement and layout. Also, the use of cookies across network domains could be supported or used with any other suitable web pages.

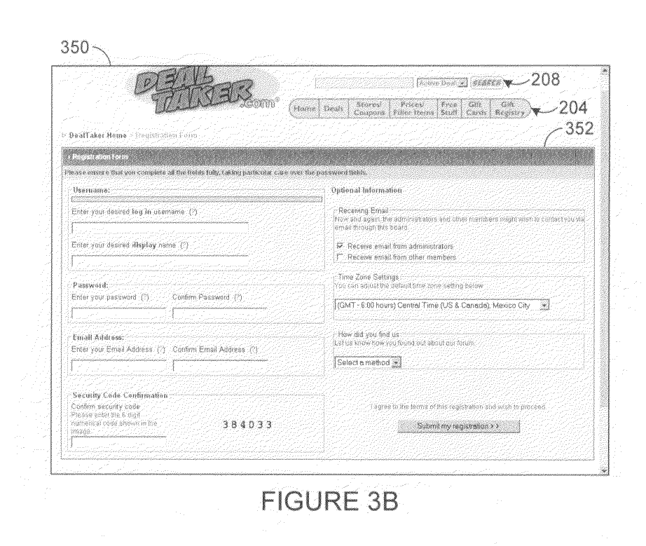

FIGS. 3A and 3B illustrate example web pages supporting login and registration functions based on access to user cookies between network domains according to this disclosure. In particular, FIGS. 3A and 3B illustrate example web pages that allow a user to log into and register with a network domain. The web pages shown in FIGS. 3A and 3B are for illustration only. Any other suitable web pages could be used without departing from the scope of this disclosure.

As shown in FIG. 3A, a web page 300 is similar to the web page 280 shown in FIG. 2C. In this example, the user has selected the “Log In” option in the login information and controls 206. This causes a login box 302 to be displayed to the user. The login box 302 allows the user to enter his or her username and password. The user is also given the option of allowing the user device and/or the network domain to “remember” the user so that the user does not need to log into the network domain at a later time.

As described above, the web pages 200, 240, and 280 could be associated with different network domains, such as the domains 106a-106n. Also, each of the web pages 200, 240, and 280 shown in FIGS. 2A through 2C could use the same or similar login box 302 to allow users to log into the various network domains 106a-106n. Moreover, one of the network domains (such as the www.dealtaker.com domain associated with the web page 200) could be the primary domain. The other network domains (such as the www.gifttaker.com and www.pricetaker.com domains associated with the web pages 240 and 280) could be the secondary domains. When a user uses the login box 302 to log into the primary domain, the user's cookie in the primary domain can be retrieved and used during the login process. When a user uses the login box 302 to log into one of the secondary domains, the user's cookie (or related information) can be retrieved from the primary domain and used during the login process. In particular embodiments, an “include” HTML command can be used to pass a cookie, token, or other information from the primary domain to the secondary domain. As a result, the same user cookie and its associated preferences and other information can be used in multiple network domains.

As shown in FIG. 3B, a web page 350 is used to allow a user to register with the network domains. The registration form 352 can be displayed to the user when the user selects the “Register” option in the login information and controls 206. The web page 350 includes a registration form 352, which includes various fields filled in, selected, or completed by the user. The registration form 352 is used to collect various information, such as a username and password, for registering the user with the network domains.

In this example, the registration form 352 is being displayed by the server 108a in the primary network domain (as shown by the www.dealtaker.com logo). In some embodiments, the registration form 352 is only displayed by the server in the primary network domain. In these embodiments, if the user attempts to register through a secondary domain, the user can be redirected to the web page 350 in the primary network domain. The primary network domain can then receive information from the user via the form 352, generate and store a user cookie, and redirect the user back to the secondary domain. In this way, all registrations occur in the primary domain.

In other embodiments, the contents of the registration form 352 may be defined in the primary domain, and the registration form 352 can be provided to a user who is attempting to register through a secondary domain. In these embodiments, the secondary domain can retrieve the contents of the registration form 352 from the primary domain, such as by using <script> tags in the secondary domain that point to the location in the primary domain where the fields are defined. The secondary domain can then generate a web page that includes the registration form 352 and display the web page to the user. Any information received from the user via the form 352 can be sent to the primary domain, allowing the user to register in the secondary domain and allowing the primary domain to generate and store the user cookie (without redirecting the user to the primary domain).

Although FIGS. 3A and 3B illustrate examples of web pages supporting login and registration functions based on access to user cookies between network domains, various changes may be made to FIGS. 3A and 3B. For example, each web page could include any other or additional information, and each web page could have any suitable arrangement and layout. Also, the web pages could support any other suitable technique for logging users into the network domains and for registering users with the network domains.

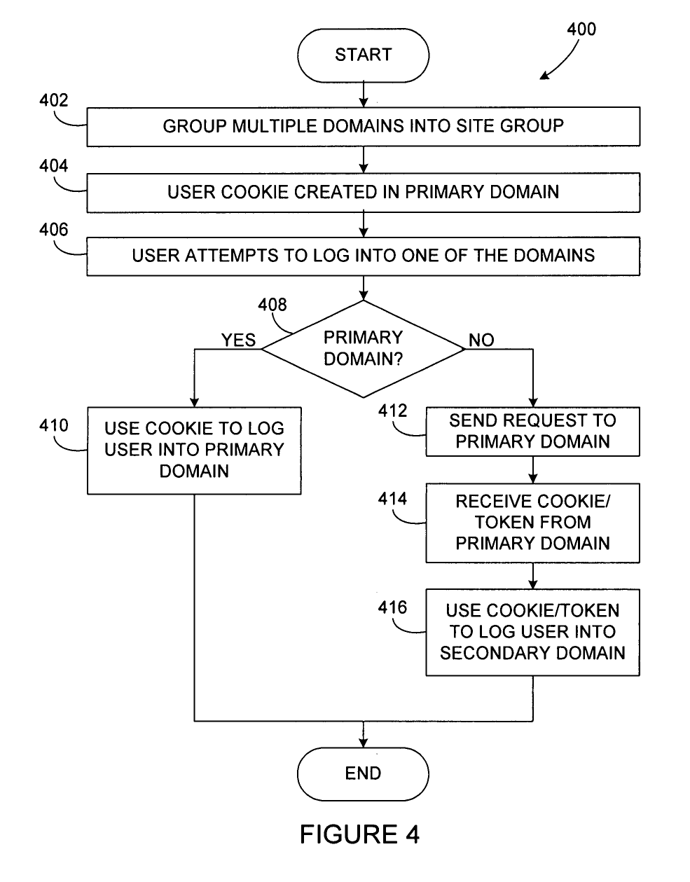

FIG. 4 illustrates an example method 400 for logging a user into a network domain using a user cookie accessible from multiple network domains according to this disclosure. The embodiment of the method 400 shown in FIG. 4 is for illustration only. Other embodiments of the method 400 could be used without departing from the scope of this disclosure.

Multiple network domains are grouped into a single site group at step 402. This could include, for example, an owner or operator of multiple network domains 106a-106n grouping the domains into a single site group 118. This could also include the owner or operator identifying one of the network domains as a primary domain, while the one or more other network domains represent secondary domains.

A user cookie associated with a user is created in the primary domain at step 404. This could include, for example, the web/application server in the primary domain (such as the server 108a) generating a cookie for the user. The cookie could be generated in response to the user completing and submitting the registration form 352 or in any other suitable manner. If the registration form 352 was presented to the user by the primary domain, the cookie could be generated based on information received by the primary domain from the user via the form 352. If the registration form 352 was presented to the user by a secondary domain, the cookie could be generated based on information received by the primary domain from the secondary domain (which itself received the information via the form 352).

Later, the user attempts to log into one of the network domains at step 406. This could include, for example, the user accessing one of the web pages 200, 240, and 280 and selecting the “Log In” option in the login information and controls 206. This may present the user with the login box 302 shown in FIG. 3A, and the user can submit his or her username and password.

If the user is attempting to log into the primary domain at step 408, the primary domain uses the user's cookie to log the user into the primary domain at step 410. This could include, for example, the web/application server in the primary domain accessing a database to retrieve the user's cookie based on the username and password provided by the user. This may also include the web/application server in the primary domain retrieving the cookie from the database and using the cookie to log the user into the primary domain. At this point, the cookie can be used in other ways, such as to present a customized web page to the user.

If the user is attempting to log into a secondary domain at step 408, the secondary domain sends a request to the primary domain at step 412. The request could, for example, include the user's username and password. The request could also be communicated using any suitable security mechanism, such as SSL. In response to the request, the secondary domain receives the user's cookie or a token from the primary domain at step 414. The primary domain may use the request from the secondary domain to locate the appropriate user's cookie and to provide the user's cookie or the token to the secondary domain. Again, the user's cookie or the token could be communicated using any suitable security mechanism, such as SSL. The secondary domain uses the user's cookie or token to log the user into the secondary domain at step 416. This could include, for example, the web/application server in the secondary domain using the retrieved cookie or token from the primary domain to log the user into the secondary domain. At this point, the cookie can be used in other ways, such as to present a customized web page to the user

Although FIG. 4 illustrates one example of a method 400 for logging a user into a network domain using a user cookie accessible from multiple network domains, various changes may be made to FIG. 4. For example, while shown as a series of steps, various steps in FIG. 4 could overlap, occur in parallel, occur multiple times, or occur in a different order. Also, cookies, tokens, or other information can be used or shared across multiple domains in any other suitable manner and for any other purpose.

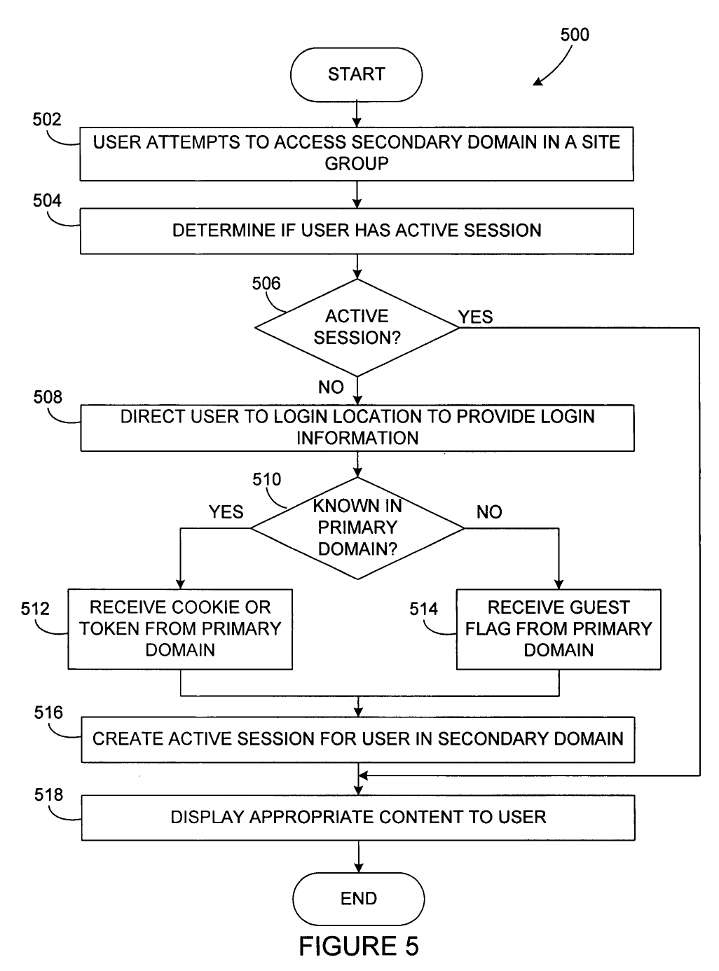

FIG. 5 illustrates an example method 500 for using, in a secondary network domain, user cookies stored in a primary network domain according to this disclosure. The embodiment of the method 500 shown in FIG. 5 is for illustration only. Other embodiments of the method 500 could be used without departing from the scope of this disclosure.

A user attempts to access a secondary network domain that has been grouped into a site group at step 502. This could include, for example, the user visiting one of the web pages 200, 240, and 280. This could also include the user logging into one of the network domains and then attempting to access a secondary domain.

The secondary domain determines if the user currently has an active session at step 504. This could include, for example, the secondary domain determining whether an active session already exists between the user and another domain in the site group 118. This could be based, for example, on information provided by the user's device during step 502.

If a session is currently active, the method 500 skips to step 518, where appropriate content is displayed to the user. At this point, the user has already logged into at least one network domain in the site group, and the user's current session can continue.

Otherwise, the user is directed to an appropriate login location at step 508. The login location could include the login box 302 that is presented to the user by the secondary domain. The login location could also represent a location within the primary domain, and the user could be redirected from the secondary domain to the primary domain. In each case, the user can then provide login information, such as a username and password, to the primary or secondary domain.

If the user is known in the primary domain at step 510, the secondary domain receives the user's cookie or token at step 512. Otherwise, the user is not known in the primary domain, and the secondary domain receives a guest flag at step 514. The guest flag indicates that the current user has not registered with the primary domain, and the guest flag can be used in the secondary domain to limit the options or functions available to the user.

In either case, an active session is created for the user in the secondary domain at step 516. This could include, for example, establishing an active session between the secondary domain and the user's device. Appropriate content, such as content based on the user's cookie, token, or guest flag, is displayed to the user at step 518.

Although FIG. 5 illustrates one example of a method 500 for using, in a secondary network domain, user cookies stored in a primary network domain, various changes may be made to FIG. 5. For example, while shown as a series of steps, various steps in FIG. 5 could overlap, occur in parallel, occur multiple times, or occur in a different order. Also, cookies from a primary domain can be used in a secondary domain in any other suitable manner and for any other purpose.

In some embodiments, various functions described above can be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
storing, in a first network domain, a cookie associated with a user;
receiving, at a second network domain, login information associated with the user;
communicating a request from the second network domain to the first network domain; and
providing the cookie or information associated with the cookie from the first network domain to the second network domain in response to the request.

2. The method of claim 1, further comprising:
logging the user into the second network domain using the cookie or the information associated with the cookie.

3. The method of claim 2, further comprising:
creating an active session associated with the second network domain and a user device used by the user.

4. The method of claim 3, further comprising:
maintaining the active session when the user device accesses the first network domain or a third network domain.

5. The method of claim 1, wherein providing the cookie or the information associated with the cookie comprises:
providing a token associated with the cookie.

6. The method of claim 1, wherein:
multiple users are capable of logging into the first and second network domains; and
multiple cookies for the multiple users are stored only in the first network domain.

7. The method of claim 1, further comprising:
receiving a registration request from the user at the second network domain or at a third network domain;
redirecting the user to the first network domain;
receiving registration information from the user at the first network domain;
generating the cookie; and
redirecting the user back to the second or third network domain.

8. The method of claim 1, further comprising:
receiving a registration request from the user at the second network domain or at a third network domain;
providing a registration form to the user, the registration form defined in the first network domain;
receiving registration information from the user using the registration form; and
communicating the registration information from the second or third network domain to the first network domain for generation of the cookie.

9. A system comprising:
a first network domain comprising at least one first server and a database; and
a second network domain comprising at least one second server;
wherein the database is configured to store a cookie associated with a user;
wherein the at least one second server is configured to receive login information associated with the user; and
wherein the at least one first server is configured to provide the cookie or information associated with the cookie to the at least one second server.

10. The system of claim 9, wherein the at least one second server is further configured to log the user into the second network domain using the cookie or the information associated with the cookie.

11. The system of claim 10, wherein the at least one second server is further configured to create an active session associated with the second network domain and a user device used by the user.

12. The system of claim 11, wherein the at least one first server is operable to maintain the active session when the user device accesses the first network domain.

13. The system of claim 9, wherein the at least one first server is configured to provide the cookie or the information associated with the cookie by providing a token associated with the cookie.

14. The system of claim 9, wherein:
the at least one second server is further configured to receive a registration request from the user and to redirect the user to the at least one first server; and
the at least one first server is further configured to receive registration information from the user, generate the cookie, and redirect the user back to the at least one second server.

15. The system of claim 9, wherein the at least one second server is further configured to:
receive a registration request from the user;
provide a registration form to the user, the registration form defined by information in the database;
receive registration information from the user using the registration form; and
communicate the registration information to the at least one first server for generation of the cookie.

16. The system of claim 9, further comprising:
a third network domain comprising at least one third server;
wherein the at least one first server is further configured to provide the cookie or the information associated with the cookie to the at least one third server.

17. The system of claim 9, wherein:
the at least one first server comprises at least one of: a first web server and a first application server; and
the at least one second server comprises at least one of: a second web server and a second application server.

18. A method comprising:
storing, in a first network domain, a cookie associated with a user;
receiving a request for the cookie or information associated with the cookie from a second network domain; and
providing the cookie or the information associated with the cookie to the second network domain.

19. The method of claim 18, wherein the second network domain creates an active session associated with a user device used by the user; and
further comprising maintaining the active session when the user device accesses the first network domain.

20. The method of claim 18, wherein providing the cookie or the information associated with the cookie comprises providing a token associated with the cookie.

21. The method of claim 18, wherein:
multiple users are capable of logging into the first and second network domains; and
multiple cookies for the multiple users are stored only in the first network domain.

22. The method of claim 18, further comprising:
providing a registration form to the user after the user is redirected from the second network domain or a third network domain to the first network domain;
receiving registration information from the user using the registration form;
generating the cookie; and
redirecting the user back to the second or third network domain.

23. The method of claim 18, further comprising:
providing information defining a registration form to the second network domain or to a third network domain;
receiving registration information from the second or third network domain, the registration information collected from the user using the registration form; and
generating the cookie.

24. An apparatus associated with a first network domain, comprising:
at least one memory configured to store a cookie associated with a user; and
at least one processor configured to:
receive a request for the cookie or information associated with the cookie from a second network domain; and
provide the cookie or the information associated with the cookie to the second network domain.

25. The apparatus of claim 24, wherein the at least one processor is further configured to maintain an active session when a user device associated with the user accesses the first network domain.

26. The apparatus of claim 24, wherein the at least one processor is configured to provide the cookie or the information associated with the cookie by providing a token associated with the cookie.

27. The apparatus of claim 24, wherein:
multiple users are capable of logging into the first and second network domains; and
multiple cookies for the multiple users are stored only in the first network domain.

28. The apparatus of claim 24, wherein the at least one processor is further configured to:
provide a registration form to the user after the user is redirected from the second network domain or a third network domain to the first network domain;
receive registration information from the user using the registration form;
generate the cookie; and
redirect the user back to the second or third network domain.

29. The apparatus of claim 24, wherein the at least one processor is further configured to:
provide information defining a registration form to the second network domain or to a third network domain;
receive registration information from the second or third network domain, the registration information collected from the user using the registration form; and
generate the cookie.

30. A computer program embodied on a computer readable medium, the computer program comprising computer readable program code for:
storing a cookie associated with a user in a first network domain;
receiving a request for the cookie or information associated with the cookie from a second network domain; and
providing the cookie or the information associated with the cookie to the second network domain.

31. A method comprising:
receiving, at a first network domain, login information from a user;
communicating a request from the first network domain to a second network domain;
receiving a cookie associated with the user or information associated with the cookie from the second network domain in response to the request; and
logging the user into the first network domain using the cookie or the information associated with the cookie.

32. The method of claim 31, further comprising:
creating an active session associated with the first network domain and a user device used by the user.

33. The method of claim 32, further comprising:
transferring the active session when the user device accesses the second network domain or a third network domain.

34. The method of claim 31, wherein receiving the cookie or the information associated with the cookie comprises receiving a token associated with the cookie.

35. The method of claim 31, wherein:
multiple users are capable of logging into the first and second network domains; and
multiple cookies for the multiple users are stored only in the second network domain.

36. The method of claim 31, further comprising:
receiving a registration request from the user at the first network domain; and
redirecting the user to the second network domain for registration.

37. The method of claim 31, further comprising:
receiving a registration request from the user at the first network domain;
receiving information defining a registration form from the second network domain;
providing the registration form to the user;
receiving registration information from the user using the registration form; and
communicating the registration information from the first network domain to the second network domain for generation of the cookie.

38. An apparatus associated with a first network domain, comprising:
at least one network interface configured to communicate over a network; and
at least one processor configured to:
receive login information from a user;
communicate a request to a second network domain;
receive a cookie associated with the user or information associated with the cookie from the second network domain in response to the request; and
log the user into the first network domain using the cookie or the information associated with the cookie.

39. The apparatus of claim 38, wherein the at least one processor is further configured to:
create an active session associated with the first network domain and a user device used by the user.

40. The apparatus of claim 39, wherein the at least one processor is further configured to:
transfer the active session when the user device accesses the second network domain or a third network domain.

41. The apparatus of claim 38, wherein the at least one processor is configured to receive the cookie or the information associated with the cookie by receiving a token associated with the cookie.

42. The apparatus of claim 38, wherein:
multiple users are capable of logging into the first and second network domains; and
multiple cookies for the multiple users are stored only in the second network domain.

43. The apparatus of claim 38, wherein the at least one processor is further configured to:
receive a registration request from the user at the first network domain; and
redirect the user to the second network domain for registration.

44. The apparatus of claim 38, wherein the at least one processor is further configured to:
receive a registration request from the user at the first network domain;
receive information defining a registration form from the second network domain;
provide the registration form to the user;
receive registration information from the user using the registration form; and
communicate the registration information from the first network domain to the second network domain for generation of the cookie.

45. A computer program embodied on a computer readable medium, the computer program comprising computer readable program code for:
receiving login information from a user at a first network domain;
communicating a request from the first network domain to a second network domain;
receiving a cookie associated with the user or information associated with the cookie from the second network domain in response to the request; and
logging the user into the first network domain using the cookie or the information associated with the cookie.

46. A method comprising:
receiving, at a first network domain, a registration request from a user;
receiving information defining a registration form from a second network domain;
providing the registration form to the user;
receiving registration information from the user using the registration form; and
communicating the registration information to the second network domain for generation of a user cookie.
